(19) United States
(12) Patent Application Publication
(10) Pub. No.: US 2012/0300212 A1
(43) Pub. Date: Nov. 29, 2012

(54) ARRANGEMENT FOR DETECTING MARKS ON REFLECTIVE MATERIAL FOR REGULATING REGISTRATION ON PRINTING MACHINES

(75) Inventor: Wolfgang Lüdge, Schulzendorf (DE)

(73) Assignee: Siemens Aktiengesellschaft, Munchen (DE)

(21) Appl. No.: 13/577,785

(22) PCT Filed: Feb. 5, 2011
(86) PCT No.: PCT/DE11/00112

§ 371 Date: Aug. 8, 2012

(30) Foreign Application Priority Data
Feb. 10, 2010 (DE) 10 2010 007 421.7

(51) Int. Cl. G01N 21/47; G01N 21/55

(52) U.S. Cl. 356/446; 356/445

(57) ABSTRACT

An arrangement for detecting marks on reflective material for regulating registration on printing machines includes a camera, a reflector plate with an opening, a light protection element and an illuminating element. The camera is arranged behind the opening of the reflector plate to record an image of the registration marks through the opening. The reflector plate can be flat or curved inwards like a parabola, and has a light protection element on the edges thereof. The flat reflector plate must be at least big enough that the plate edges reflected on the web material lie outside the mark regions to be recorded. The illuminating element is arranged inside the light protection element, and the surface of the reflector plate and the surface of the light protecting element are a white diffusely reflecting colour, on the sides facing the reflective web material.

The invention relates to an arrangement for detecting marks on reflective material for regulating registration on printing machines, making use of a camera and an illuminating element.

The principle is known in the printing industry of using cameras with illuminating devices for detecting marks for regulating registration.

The arrangements known hitherto for detecting marks for regulating registration conduct the light at a specific angle to the optical axis of the camera, such that, if the surface of the web material is glossy, the light source is not reflected directly into the camera. With such an arrangement, the printed mark has an adequate contrast due to the preponderantly diffuse reflection of the web material, and can therefore be detected by the camera. With strongly reflective surfaces, however, in accordance with the law of regular reflection, the light is almost completely reflected past the lens, such that the camera, due to lack of diffuse reflection, detects a dark image, in which no marks are identifiable. Solutions are also known from industrial image processing which function with a ring lamp formed from individual light-emitting diodes (LED's) around the camera lens. With reflective surfaces, however, the LED ring will be reflected into the camera by such an illuminating element, and therefore superimposed with the marks which are detected. This accordingly impedes an unambiguous evaluation of the marks. An arrangement for detecting marks on reflective material is known from DE 103 39 651 B3.

The invention is based on the object of providing an arrangement which allows for the detection of marks on reflective surfaces by a camera.

This object is achieved by claims 1 to 3. In particular, it is achieved in that a plate (2) is arranged in front of the camera (1), said plate functioning as a reflector and containing an opening (3), and that behind the opening the lens (4) of the camera is arranged in such a way that the camera can detect an image of the registration marks through the opening (3), that the dimensions of the flat plate are selected to be at least big enough that the plate edges (8) reflected on the web material (9) lie outside of the mark region (7) to be recorded, that a light protection element (5) is located at the edges of the flat plate, and that the illuminating element (6) is arranged inside the light protection element. In order to obtain a uniform brightness distribution on the reflective surface, the plate (2) is expediently designed as a flat plate. If it transpires to be necessary, however, for the dimensions of the reflector to be kept as small as possible, the plate (3) can also be designed in a curved shape, e.g. as a parabola, with the opening (3) located at the lower vertex of the curved shape. The distance interval between the reflector walls (5) can in this case be reduced to the mark region to be recorded plus a safety interval. The curved plate then causes an inhomogeneous brightness distribution on the reflective surface, with higher brightness values at the edge of the image detected by the camera in comparison with the middle of the image. It is also expedient for the surface of the plate (2) and the surface of the light protection element (5) to be provided with a white diffusely reflecting color on its sides which face towards the reflective web material.

The advantage achieved with the invention consists in particular of the fact that marks on reflective surfaces can be detected by a camera with a very good contrast between mark and reflective surroundings.

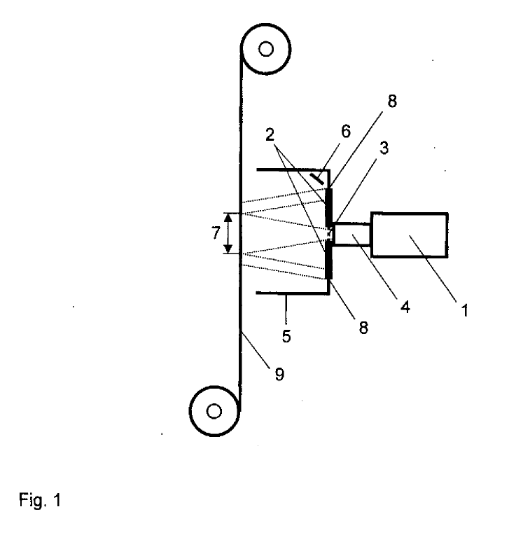

The invention is explained in greater detail below with reference to FIG. 1. A camera (1) is arranged in front of a reflective web material (9), which is printed by a printing machine and on which there are registration marks in a region (7), with the lens (4) directly behind the opening (3) of the reflector plate (2). The opening of the reflector plate is expediently designed in such a way that the edges are not detected by the camera, but at the same time a minimal opening is provided. This can be achieved, for example, by means of a circular or rectangular opening, the dimensions of which are sufficiently large for the edges of the opening to be imaged outside of the image sensor, and with a safety interval. A light protection element (5) is located on the reflector plate (2), which ensures that the light emitted by the illuminating element (6) and reflected by the reflective surface (9) adequately lights the reflector plate (2). The reflector plate illuminated in this way reflects on the web material (9). Colored or grey registration marks in the region (7) exhibit a good contrast against the reflected and expediently white reflector plate, and can in this way be detected by the camera (1). In order for the dark imaging of the opening (3) on the reflective web material (9) not to be superimposed on the registration marks, the arrangement according to the invention is to be expediently positioned in relation to the marks in such a way that the reflector opening (3) is imaged next to the marks.

1-7. (canceled)

8. An arrangement for detecting a mark on a reflective web material for regulating registration on a printing machine, comprising:
a camera having a lens:
a plate having a curved shape and arranged in front of the camera, with the lens of the camera arranged behind an opening of the plate, said plate dimensioned at least of a size sufficient for plate edges reflected on the web material to lie outside of a mark region which is to be detected;
a light protection element attached on the plate edges; and
an illuminating element arranged inside the light protection element.

9. The arrangement of claim 8, wherein the plate is configured in the form of a parabola.

10. The arrangement of claim 8, wherein the opening is located at a lower vertex of the curved shape.

11. The arrangement of claim 8, wherein the opening is sized sufficient for edges thereof to be imaged outside of an image sensor with a safety interval.

12. The arrangement of claim 8, wherein a surface of the plate and a surface of the light protection element have a white diffusely reflecting color on their sides which face towards a reflective surface.

13. The arrangement of claim 8, positioned in relation to the mark in such a way that the opening of the plate is imaged next to the mark.

14. An arrangement for detecting a mark on a reflective web material for regulating registration on a printing machine, comprising:
a camera having a lens;
a flat plate arranged in front of the camera, with the lens of the camera arranged directly behind an opening of the plate, said plate dimensioned at least of a size sufficient for plate edges reflected on the web material to lie outside of a mark region which is to be detected;
a light protection element attached on the plate edges; and
an illuminating element arranged inside the light protection element.

15. The arrangement of claim 14, wherein the opening is sized sufficient for edges thereof to be imaged outside of an image sensor with a safety interval.

16. The arrangement of claim 14, wherein a surface of the plate and a surface of the light protection element have a white diffusely reflecting color on their sides which face towards a reflective surface.

17. The arrangement of claim 14, positioned in relation to the mark in such a way that the opening of the plate is imaged next to the mark.

18. An arrangement for detecting a mark on a reflective web material for regulating registration on a printing machine, comprising:
a camera having a lens;
a flat plate arranged in front of the camera, with the lens of the camera arranged behind an opening of the plate, said plate dimensioned at least of a size sufficient for plate edges reflected on the web material to lie outside of a mark region which is to be detected;
a light protection element attached on the plate edges; and
an illuminating element arranged inside the light protection element
wherein the camera is arranged outside the light protection element.

19. The arrangement of claim 18, wherein the opening is sized sufficient for edges thereof to be imaged outside of an image sensor with a safety interval.

20. The arrangement of claim 18, wherein a surface of the plate and a surface of the light protection element have a white diffusely reflecting color on their sides which face towards a reflective surface.

21. The arrangement of claim 18, positioned in relation to the mark in such a way that the opening of the plate is imaged next to the mark.
